(19) United States
(12) Patent Application Publication
(10) Pub. No.: US 2005/0274051 A1
(43) Pub. Date: Dec. 15, 2005

(54) Apparatus for recording pet care instructions

(76) Inventors: Alisa Anne Benson, Minneapolis, MN (US); Sean Christopher Benson, Minneapolis, MN (US)

Correspondence Address: SEAN BENSON, 3337 IRVING AVE. S., MINNEAPOLIS, MN, 55408, US

(21) Appl. No.: 10/866,481

(22) Filed: Jun. 12, 2004

(51) Int. Cl. G09F 7/04

(52) U.S. Cl. 40/600; 434/408

(57) ABSTRACT

An apparatus for recording pet care instructions with a dry-erase board surface that allows the user to record and edit pet instructions, pre-printed phrases and lines on the dry-erase board that provide a prompt to the user to record the pet instructions, a dry-erase pen that allows the user to record the pet instructions and that is attached to the dry-erase board and magnetic backing on the dry-erase board that allows the dry-erase board to be attached to a refrigerator or similar object.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pet care and more specifically to an apparatus for recording pet care instructions. This invention relates to an apparatus for assisting in the orderly recording of pet instructions for pet owners. Many times, pet owners must leave their pets in the care of others, whether they be friends, family members or pet sitters. In each case, it is important to enumerate the specific pet care instructions for the person who will be taking care of the pet. Many different types of information must be recorded in some manner. This invention presents a set of pre-printed text phrases that provide a guide to the pet owner to record specific information about the care of the pet. Current methodologies for recording pet instructions are limited to the use of paper to write down specific instructions. Typically, a pet owner will use a sheet of blank paper and write down the relevant pet instruction information that comes to mind at that moment. Then, once the pet owner returns and can care for the pet, those instructions are discarded, never to be used again.

There are many shortcomings to the use of paper for pet instructions. Primarily, the pet owner typically re-writes all instructions each time they leave their pet in the care of someone else. This takes time for the pet owner and is redundant. Also, the lack of a template to guide the pet owner increases the possibility that the pet owner will forget to record some important piece of information. Additionally, if the pet owner keeps the same piece of paper and provides it multiple times for the pet sitter, the pet owner will have to cross out and write in new information as the pet care instructions change. This creates a messy and hard-to-follow set of instructions.

With this invention, the pet owner has a pre-printed set of text phrases that provide a guide to the pet owner to enter the appropriate pet care information. Additionally, as the pet care instructions change over time, the pet owner can simply erase the previous instructions and record new instructions with the dry erase pen. Finally, the invention has a magnetic backing, which allows for the attachment of the invention to an object, like a refrigerator, which allows for ease of access to the information.

### BRIEF SUMMARY OF THE INVENTION

The primary advantage of the invention is to provide an apparatus for the efficient and thorough recording and editing of pet instructions.

Another advantage of the invention is to provide an apparatus in which the pet instructions can be easily accessible.

Another advantage of the invention is to provide an apparatus with pre-printed text phrases which guide the pet owner to enter specific pet instructions.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an apparatus for recording pet care instructions, comprising: A dry-erase board surface that allows the user to record and edit pet instructions, pre-printed phrases and lines on said dry-erase board that provide a guide to the user to write in said pet instructions, a dry-erase pen that allows the user to write in said pet instructions and that is attached to said dry-erase board, and magnetic backing on said dry-erase board that allows said dry-erase board to be attached to a refrigerator or similar object.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the front of the invention for one pet.

FIG. 2 is a plan view of the back of the invention for one pet.

FIG. 3 is a plan view of the front of the invention for more than one pet.

FIG. 4 is a plan view of the back of the invention for more than one pet.

### DETAILED DESCRIPTION OF THE PREFERRED EMBODIMENTS

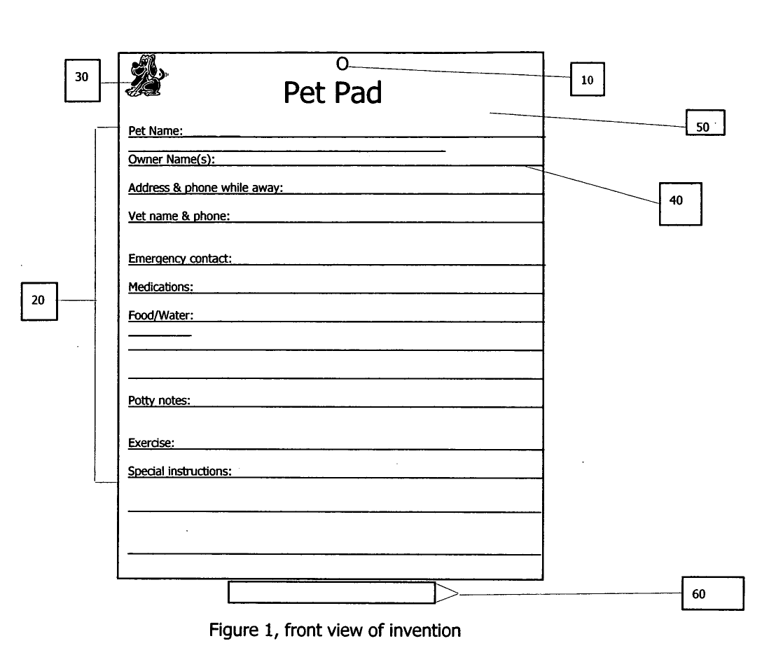

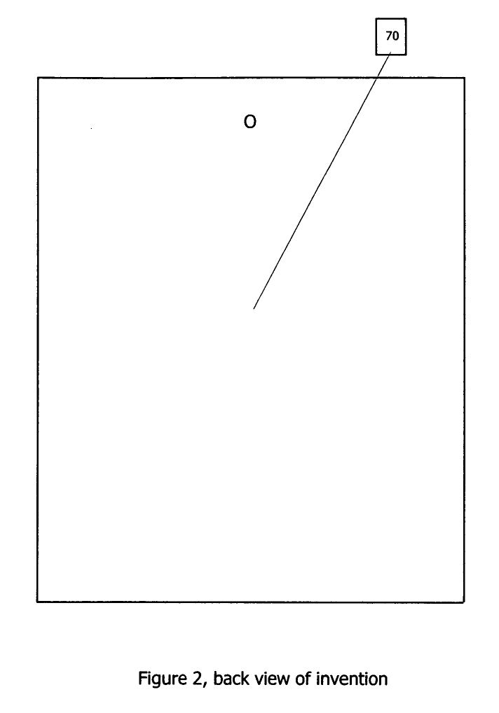

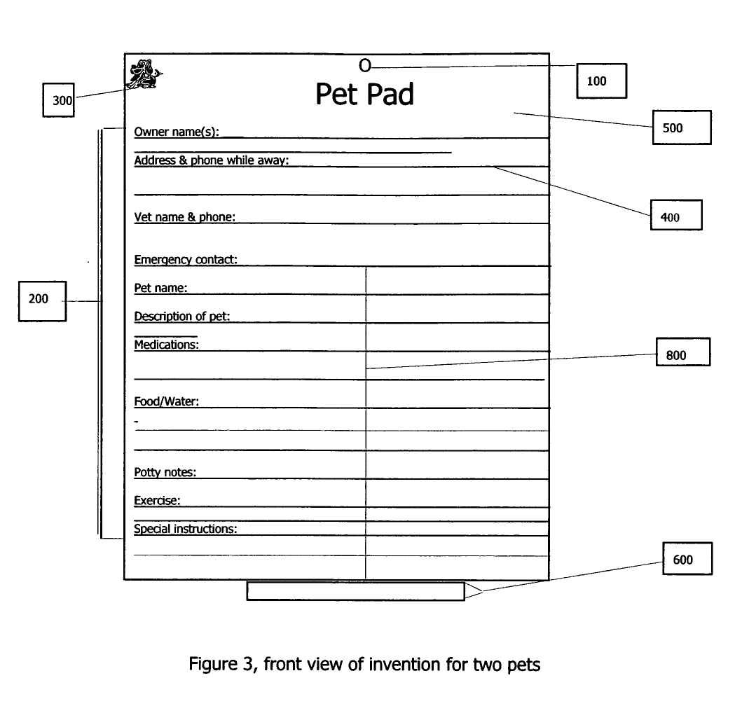

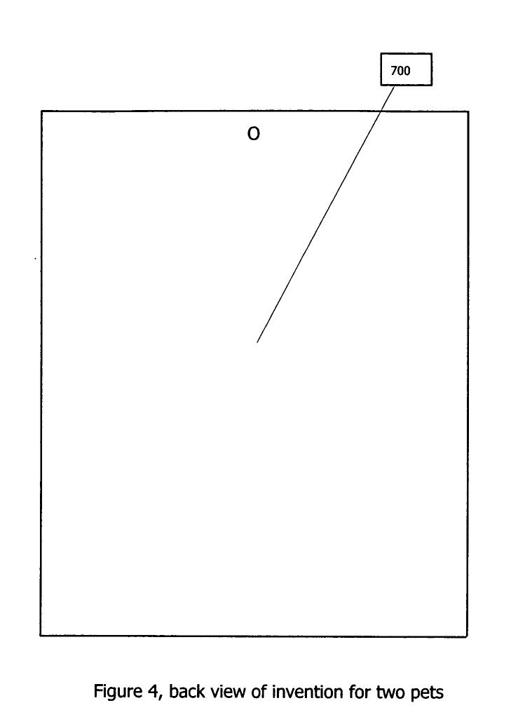

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. The present invention comprises an apparatus to allow pet owners to record pet care instructions on a dry erase board. The apparatus comprises a dry erase board with pre-printed text (number 20 in FIG. 1 and number 200 in FIG. 3) and lines (number 40 in FIG. 1 and number 400 in FIG. 3) to guide a pet owner on what information the pet owner needs to record for another person who will take care of the pet in the owner's absence. The pre-printed text is a key component of the invention and provides the user with proper guidance on what information needs to be recorded on the dry erase board. The dry erase board has a magnetic backing (number 70 in FIG. 2 and number 700 in FIG. 4) so that the invention can be attached to a refrigerator or similar object. The combination of these key components makes the invention unique.

The apparatus allows for blank space after each pre-printed text phrase to prompt the user to record specific instructions for each section, including the following in FIG. 1:

1. Pet name: This section is used to record the name of the pet.

2. Owner name(s): This section is used to record the name of the pet owner(s).

3. Address & phone while away: These two sections are used to record the address and phone number of the pet owner(s) while they are away.

4. Vet name & phone: This section is used to record the name and phone number of the veterinarian that cares for the pet. This information may be useful if the pet has a medical issue while the owner is away.

5. Emergency contact: This section is used to record any contact information (for example name and phone) of an emergency contact, such as a friend of the pet owner who lives nearby.

6. Medications: This section is used to record any medications that the pet is taking, including dose amounts and frequency.

7. Food/water: These sections are used to record any feeding instructions for the pet, including food and water.

8. Potty notes: This section is used to record any instructions concerning the voiding activities of the pet.

9. Exercise: This section is used to record any exercise instructions for the pet.

10. Special instructions: These sections are used to record any other information that has not been recorded in the previous sections.

11. There is a clip that can be attached to any edge of the board. This clip holds the dry erase pen (number 60 in FIG. 1 and number 600 in FIG. 3). This dry-erase pen may be attached to the dry-erase board in numerous ways, including the use of Velcro or clips.

12. Surface: White board whose surface allows for the writing and erasing of ink, commonly called Dry Erase Board (number 50 in FIG. 1 and number 500 in FIG. 3). The magnetic backing on the back of the board allows the board to be attached to a variety of objects, including a refrigerator. The magnetic backing may be removed if the user does not wish to apply the dry-erase board to an object like a refrigerator.

13. Graphics: The dry-erase board surface may contain graphics, including pictures of pets (number 30 in FIG. 1 and number 300 in FIG. 3).

14. Other means of attaching dry-erase board: The dry-erase board may contain one or more openings in the top of the dry-erase board so that the dry-erase board can be attached more securely to another surface with a tack or similar affixing mechanism (number 10 in FIG. 1 and number 100 in FIG. 3).

15. Removable labels: The pre-printed text and lines may not necessarily be printed on to the dry-erase board, they may be printed onto removable labels that can be arranged to the satisfaction of the user.

Another variation of this invention is a pet instruction board for more than one pet (FIG. 3). The components of this variation include all of the above characteristics enumerated for the single pet board (FIG. 1), plus:

1. Description of Pet: This section allows the user to describe each individual pet for whom instructions are being recorded.

2. Any pre-printed text items that are constant for the pets (ex. Owner Name) are included at the top of the board. Pre-printed text items that vary from pet to pet are listed in the lower section of the board. There is a vertical line (number 800 in FIG. 3) that runs through the middle of the board that allows the separate entry of instructions for those items which vary from pet to pet (ex. Pet Name).

Currently, pet instructions are recorded with paper in a manner which is not consistent. This invention improves the process by which pet care instructions are recorded. The key advantages to this invention over current methods are the following:

1. Pre-printed text phrases provide prompts to the pet owner so that they remember to record on the dry erase board all of the key elements of their pet care instructions.

2. Dry erase board surface allows the pet owner to erase and write in new instructions as they change.

3. Magnetic backing on the dry erase board allows the pet owner to attach the dry erase board to a refrigerator or other object.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An apparatus for recording pet care instructions comprising:
A dry-erase board surface that allows the user to record and edit pet instructions;
pre-printed phrases and lines on said dry-erase board that prompt the user to write in said pet instructions;
a dry-erase pen that allows the user to write in said pet instructions and that is attached to said dry-erase board; and
magnetic backing on said dry-erase board that allows said dry-erase board to be attached to a refrigerator or similar object.

2. An apparatus for recording pet care instructions as claimed in claim 1 further comprising:
said dry-erase board may allow for the recording of said pet instructions for more than one pet.

3. An apparatus for recording pet care instructions as claimed in claim 1 further comprising:
said magnetic backing may be removed if the user does not wish to apply said dry-erase board to an object like a refrigerator.

4. An apparatus for recording pet care instructions as claimed in claim 1 further comprising:
said dry-erase pen may be attached to said dry-erase board in numerous ways, including the use of Velcro or plastic clips.

5. An apparatus for recording pet care instructions as claimed in claim 1 further comprising:
said dry-erase board may contain graphics, including pictures of pets.

6. An apparatus for recording pet care instructions as claimed in claim 1 further comprising:
said dry-erase board may contain one or more openings in the top of said dry-erase board so that said dry-erase board can be attached more securely to another surface with a tack or similar affixing mechanism.

7. An apparatus for recording pet care instructions as claimed in claim 1 further comprising:
said pre-printed text and lines may not necessarily be printed on to said dry-erase board, they may be printed onto removable labels that can be arranged to the satisfaction of the user.
